(19) United States
(12) Patent Application Publication
(10) Pub. No.: US 2021/0081964 A1
(43) Pub. Date: Mar. 18, 2021

(54) METHOD FOR DETECTING SUSPICIOUS GROUPS IN COLLABORATIVE STOCK TRANSACTIONS BASED ON BIPARTITE GRAPH

(71) Applicants: XI'AN JIAOTONG UNIVERSITY, Xi'an (CN); CHINA MERCHANTS SECURITIES CO., LTD., Shenzhen (CN)

(72) Inventors: Ting LIU, Xi'an (CN); Jixiang ZHENG, Shenzhen (CN); Lingyi HUANG, Shenzhen (CN); Jingwei ZHOU, Xi'an (CN); Yimin LIU, Xi'an (CN); Yadong ZHOU, Xi'an (CN)

(21) Appl. No.: 17/105,513

(22) Filed: Nov. 26, 2020

Related U.S. Application Data
(63) Continuation of application No. PCT/CN2019/115103, filed on Nov. 1, 2019.

(30) Foreign Application Priority Data
Jul. 1, 2019 (CN) 201910585215.7

(51) Int. Cl. G06Q 30/00; G06Q 40/04; G06Q 40/00; G06Q 20/40

(52) U.S. Cl. CPC G06Q 30/0185; G06Q 40/04; G06Q 50/26; G06Q 20/407; G06Q 40/12

(57) ABSTRACT

The present disclosure discloses a method for detecting suspicious groups in collaborative stock transactions based on a bipartite graph. The method includes: determining transaction events and suspicious accounts as two different kinds of nodes of the bipartite graph based on historical stock transaction data, and searching for a transaction event and filtering out a suspicious account in an iterative updating loop until a set of transaction events and a set of suspicious accounts have converged; and constructing a collaborative transaction graph among accounts based on the set of transaction events and the set of suspicious accounts that have converged, performing a community division based on the collaborative transaction graph among accounts to determine one or more account communities that perform the collaborative stock transactions, and determining the one or more account communities as the suspicious groups in the collaborative stock transactions.

### CROSS-REFERENCE TO RELATED APPLICATIONS

The present application is a continuation of International Application No. PCT/CN2019/115103, filed on Nov. 1, 2019, which claims priority to Chinese Patent Application No. 201910585215.7, filed on Jul. 1, 2019, both of which are hereby incorporated by reference in their entireties.

### TECHNICAL FIELD

The present disclosure relates to the field of information technologies, and more particularly, to a method for detecting suspicious groups in collaborative stock transactions based on a bipartite graph.

### BACKGROUND

A stock is a certificate of ownership issued by a joint-stock company and a kind of securities that the joint-stock company issues to each shareholder as a certificate of shareholding so as to raise funds. Each shareholder obtains dividends and bonuses from the stock. Each share of stock represents a basic unit of ownership of the company held by a shareholder. Every listed company issues stocks.

Stocks are a component of the capital of the joint-stock company, and a main long-term credit tool in the capital market. Stocks may be transferred, bought, and sold, but shareholders cannot require the company to return their capital contributions. In the secondary market, trader groups of a certain scale may commission a certain stock according to certain rules, thereby significantly affecting the price trend of the stock. Deliberately manipulating the stock price with the rules will damage normal functioning of the stock market.

However, there are lacks of technical solutions for dividing stock traders into communities based on historical transaction data of stock traders in the secondary market. A reasonable and effective community division of stock traders may not only assist securities regulatory authorities in compliance supervision, but also assist the government, enterprises, and individual investors in market forecasting.

### SUMMARY

The present disclosure aims to provide a method for detecting suspicious groups in collaborative stock transactions based on a bipartite graph, so as to meet the current demand for a community discovery of group behavior characteristics of traders in the secondary market.

To achieve the above objective, the present disclosure adopts the following technical solutions.

A method for detecting suspicious groups in collaborative stock transactions based on a bipartite graph is provided. The method includes collecting a set of suspicious accounts and a set of transaction events. The method further includes: step S101) of determining whether an update occurs in the set of suspicious accounts: in response to that the update occurs, proceeding to step S102); otherwise, proceeding to step S106); step S102) of searching for a transaction event: retrieving historical stock transaction data of each suspicious account in the set of suspicious accounts to construct a transaction event, and adding the constructed transaction event to a set of candidate transaction events; step S103) of calculating a transaction event participation threshold: calculating the transaction event participation threshold based on a size of the set of transaction events, a size of the set of candidate transaction events, or iteration history; step S104) of updating the set of transaction events: calculating a participation degree of each candidate transaction event in the set of candidate transaction events, selecting a candidate transaction event having a participation degree higher than the transaction event participation threshold, and adding the candidate transaction event having the participation degree higher than the transaction event participation threshold to the set of transaction events; and after the addition, clearing the set of candidate transaction events; step S105) of determining whether the set of suspicious accounts and the set of transaction events have converged: determining whether elements included in the set of suspicious accounts and the set of transaction events are the same before and after a latest update; in response to that the elements included in the set of suspicious accounts and the set of transaction events are not the same, determining that the set of suspicious accounts and the set of transaction events have not converged, and proceeding to step S101); and in response to that the elements included in the set of suspicious accounts and the set of transaction events are the same, determining that the set of suspicious accounts and the set of transaction events have converged, and proceeding to step S109); step S106) of searching for a suspicious account: retrieving historical stock transaction data generated in each transaction event in the set of transaction events to select a stock account that has participated in at least one arbitrary transaction event in the set of transaction events, and adding the stock account selected to a set of candidate suspicious accounts; step S107) of calculating a suspicious account participation threshold: calculating the suspicious account participation threshold based on a size of the set of suspicious accounts, a size of the set of candidate suspicious accounts, or iteration history; step S108) of updating the set of suspicious accounts: calculating a participation degree of each stock account in the set of candidate suspicious accounts, selecting a stock account having a participation degree higher than the suspicious account participation threshold as a suspicious account, and adding the suspicious account selected to the set of suspicious accounts; and after the addition, clearing the set of candidate suspicious accounts; step S109) of constructing a collaborative transaction graph among accounts: constructing the collaborative transaction graph among accounts describing collaboration situations of all suspicious accounts on all transaction events; and step S110) of performing a group division based on the collaborative transaction graph among accounts: dividing the collaborative transaction graph among accounts into a plurality of account communities each having close internal collaboration based on a collaboration degree, determining the plurality of account communities each having the close internal collaboration as the suspicious groups in the collaborative stock transactions, and determining transaction events manipulated or participated by the suspicious groups as a group of transaction events; and outputting the suspicious groups in the collaborative stock transactions and the group of transaction events manipulated or participated by the suspicious groups, and terminating the detecting.

Further, in response to performing step S101) for the first time, original inputs are accepted as the set of suspicious accounts ACC and the set of transaction events STK, and at least one of the original inputs has a valid value. In response to that step S101) is entered for the first time based on the original inputs and the set of suspicious accounts in the original outputs has a valid value, or in response to that step S101) is entered in a loop based on an algorithm and the set of suspicious accounts is updated relative to a previous entrance to step S101), the method proceeds to step S102); otherwise, the method proceeds to step S106).

Further, an initial value of the set of suspicious accounts in step S101) is a set of stock accounts that are confirmed to have abnormal transactions based on prior information or that are subjectively suspected of abnormal transactions. An arbitrary element in the set of suspicious accounts in step S101) that is a suspicious account is a personal stock account opened individually or an institutional stock account that was registered with a brokerage firm or other legal securities institutions, and has been closed or is still in use.

Further, an initial value of the set of transaction events in step S101) is a set of transaction events that are confirmed to have abnormal transactions based on prior information or that are subjectively suspected of abnormal transactions. An arbitrary element in the set of transaction events in step S101) that is a transaction event is a triplet including a traded stock stk, beginning time t_{b}, and end time tₑ. An abnormal transaction of the stock stk occurs between the beginning time t_{b} and the end time tₑ. The beginning time t_{b} is earlier than the end time tₑ. For the same transaction event, an interval between the beginning time t_{b} and the end time tₑ is not greater than a positive threshold t_{gap}. An arbitrary transaction event is denoted by (stk, t_{b}, tₑ)|t_{b}<tₑ, tₑ−t_{b}<t_{gap}, t_{gap}>0.

The uppercase STK refers to the “set of transaction events”, and the lowercase stk refers to an unspecified “stock”.

Further, the stock transaction in step S102) and step S106) refers to an act of entrusting or revoking a stock transaction entrustment performed by a stock account, regardless of whether the stock transaction is closed or not.

Further, the transaction event participation threshold THR_{STK} in step S103) determines a minimum participation degree required for determining a candidate transaction event as a transaction event. The suspicious account participation threshold THR_{ACC} in step S107) determines a minimum participation degree required for determining a candidate stock account as a suspicious account. The transaction event participation threshold and the suspicious account participation threshold should be determined through the same or similar calculation method, and should not be strictly increased as the iterative loop progresses. The calculation method may lie in determining that an n^{th} loop includes all operations included from a (2n−1)^{th} execution of step S101) to a 2n^{th} execution of step S105). Values of both the transaction event participation threshold and the suspicious account participation threshold are determined as the natural logarithm of a number of loops, and calculated through the following formula:

THR_{STK}(n)=THR_{ACC}(n)=ln(n).

Further, the participation degree P_{STK} of each candidate transaction event in step S104) describes a degree to which each candidate transaction event is principally participated by suspicious accounts. The participation degree P_{ACC} of each stock account in step S108) describes a degree to which each candidate stock account principally participates in transaction events. The participation degree P_{STK} and the participation degree P_{ACC} should be determined through the same or similar calculation method. The calculation method may be as follows. The participation degree of each candidate transaction event is determined as a number N_{ACC} of suspicious accounts that principally participate in the candidate transaction event in the set of suspicious accounts, that is, P_{STK}=N_{ACC}. The participation degree of each stock account is determined as a number N_{STK} of transaction events in the set of transaction events that the stock account principally participates in, that is, P_{ACC}=N_{STK}. Expressions “principally participated by/principally participates in” here refer to a transaction behavior of investing most of the money in an account to a certain stock within a certain period of time, or a transaction behavior that although most of the money in the account is not invested to the stock, a transaction volume or transaction value of the account has obviously affected the normal transaction of the stock. In reality, “principally participated by/principally participates in” may be defined as follows: a sum SUM_{AMT}_{_{acc}} (a sum of a total purchase amount and a total sale amount) of transaction amounts of any suspicious account acc in any transaction event (stk, t_{b}, tₑ) is greater than an amount threshold THR_{AMT}, or the sum SUM_{AMT}_{_{acc}} of transaction amounts is greater than a certain percentage RAT_{AMT} of an average daily transaction amount AVG_{AMT}_{ₛₜₖ} of a stock stk within a period of the transaction event, that is, from the beginning time t_{b} to the end time tₑ. That is to say, when SUM_{AMT}_{_{acc}}>THR_{AMT} or SUM_{AMT}_{_{acc}}>AVG_{AMT}_{ₛₜₖ}×RAT_{AMT}, it is determined that the suspicious account acc principally participates in the transaction event (stk, t_{b}, tₑ), where THR_{AMT}>0, and RAT_{AMT}>0. Both THR_{AMT} and RAT_{AMT} are empirical parameters, which may be determined based on data analyses of the stock market and business experience.

Further, step S109) includes: for the set of suspicious accounts and the set of transaction events, calculating a collaboration degree SIM of stock transactions between any two suspicious accounts based on participation situations of the any two suspicious accounts in a transaction event, constructing the collaborative transaction graph G_{SIM} among accounts describing collaboration situations of all suspicious accounts on all transaction events by taking each suspicious account as a node, taking a collaborative stock transaction between the any two suspicious accounts as an edge, and determining a collaboration degree of the any two suspicious accounts as a weight of the edge.

Further, a collaboration degree SIM_{xy} of transactions between one stock account accₓ and another stock account acc_{y} in the set of suspicious accounts AAC is a directed collaboration degree or an undirected collaboration degree, that is, a scalar collaboration degree that reflects an overall collaboration situation of the two suspicious accounts on all events in the set of transaction events STK or a vectorial collaboration degree that independently reflects a collaboration situation of the two accounts on an event (stk, t_{b}, tₑ) in the set of transaction events in each dimension. The calculation method may be described as follows. Stock accounts accₓ and acc_{y} are set to principally participate in nₓ transaction events and n_{y} transaction events, respectively, and set to principally participate in n_{x&y} transaction events together, then the collaboration degree of the stock accounts accₓ and acc_{y} is an arithmetic mean of a ratio of the n_{x&y} transaction events that the stock accounts accₓ and acc_{y} principally participate in together to the nₓ transaction events that the stock account accₓ principally participates in and a ratio of the n_{x&y} transaction events that the stock accounts accₓ and acc_{y} principally participate in together to the n_{y} transaction events that the stock account acc_{y} principally participates in. The calculation method of the collaboration degree is referred to as a “default calculation method of the collaboration degree” in the following text, and is denoted by an equation:

$${SIM}_{x y} = ( \frac{{n}_{x \& y}}{{n}_{x}} + \frac{{n}_{x \& y}}{{n}_{y}} ) / 2 .$$

Further, an optional implementation of community discovery in step S110) may be an overlapping community discovery or a non-overlapping community discovery. An objective of the community discovery is to divide the collaborative transaction graph into a plurality of account communities each having the close internal collaboration based on a collaboration degree. The implementation selected should be compatible with the collaborative transaction graph and capable of reflecting weight characteristics of collaboration degrees of transactions among different accounts. For example, when the default calculation method of the collaboration degree is adopted, for a collaborative transaction graph G_{SIM} constructed based on the set of suspicious accounts and the set of transaction events, a DBSCAN algorithm is adopted to divide the collaborative transaction graph G_{SIM} into subgraphs (G_{SIM,1}), (G_{SIM,2}), (G_{SIM,3}) . . . and scatter points. Each subgraph is set to represent an account community. Stock accounts corresponding to all nodes included in a subgraph form a suspicious group in collaborative stock transactions of an account community corresponding to the subgraph, and transaction events corresponding to all edges included in the subgraph form a group of transaction events in the account community.

Further, the close internal collaboration in step S110) means that a ratio of a number of edges E of any two accounts having a collaboration degree SIM not smaller than a threshold SIM₀ in an account community to a number of theoretically fully connected edges E_{c} of the any two accounts is not smaller than a threshold Pᵢₙₜ, that is, E/E_{c}≥Pᵢₙₜ, where SIM₀>0, 0<Pᵢₙₜ<1. Both SIM₀ and Pᵢₙₜ are empirical parameters, which may be determined based on the actually adopted calculation method of the collaboration degree, data analyses of the stock market, and business experience.

Further, each of the plurality of suspicious groups in the collaborative stock transactions in step S110 is a set of stock accounts that synchronously participate in all transaction events in a corresponding group of transaction events and that further potentially affect a stock price trend of a related stock. The suspicious groups in the collaborative stock transactions and a corresponding group of transaction events are final outputs of the method for detecting the suspicious groups in the collaborative stock transactions.

Compared with the related art, the present disclosure has the following beneficial effects.

With the present disclosure, the historical stock transaction data of the suspicious accounts are retrieved to construct the transaction event based on the historical stock transaction data so as to update the set of transaction events. The stock account participating in the transaction event is located, and the suspicious account involved in the transaction event is filtered out to update the set of suspicious accounts. The iterative loop is applied on the above process in a certain order until the set of transaction events and the set of suspicious events have converged. The collaborative transaction graph among accounts is constructed by determining each suspicious account as the node and the collaboration situation among the any two accounts on the transaction events as the edge. The community discovery is performed on the collaborative transaction graph among accounts to detect account communities. And then, the suspicious groups in the collaborative stock transactions and corresponding transaction events are obtained.

### BRIEF DESCRIPTION OF DRAWINGS

The accompanying drawings constituting a part of the present disclosure are used to provide a further understanding of the present disclosure. Exemplary embodiments and description of the exemplary embodiments are used to explain the present disclosure and do not constitute an improper limitation of the present disclosure.

FIG. 1 is a flowchart of a method for detecting suspicious groups in collaborative stock transactions based on a bipartite graph according to the present disclosure.

### DESCRIPTION OF EMBODIMENTS

The present disclosure will be described in detail below with reference to the accompanying drawings and in combination with embodiments. It should be noted that embodiments described in the present disclosure and features of the embodiments may be combined with each other without contraction.

The following detailed description is exemplary and is intended to provide detailed description of the present disclosure. Unless otherwise specified, all technical terms used in the present disclosure have the same meanings as commonly understood by those skilled in the art to which the present disclosure belongs. The terms used in the present disclosure are only for describing specific embodiments, and are not intended to limit exemplary embodiments described in the present disclosure.

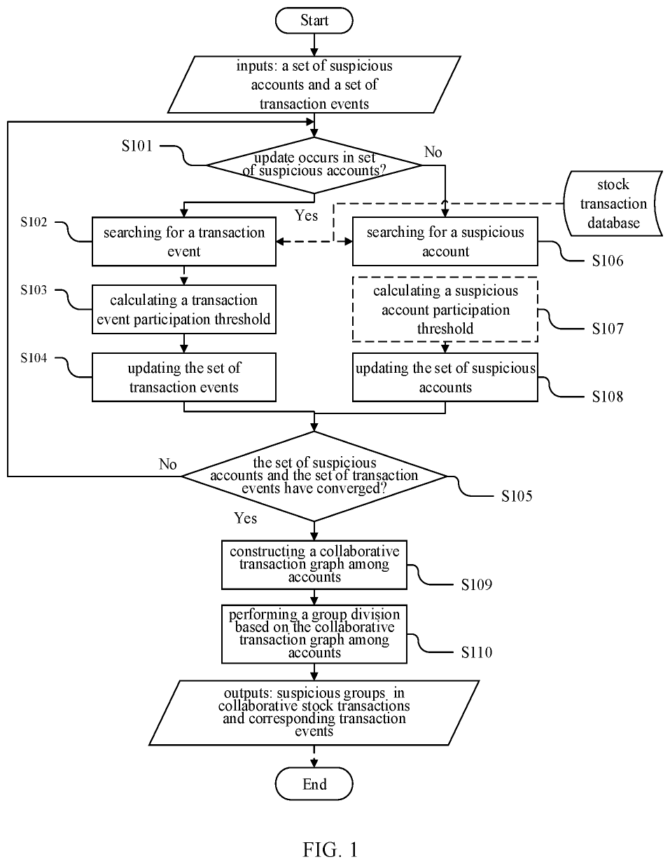

As illustrated in FIG. 1, the present disclosure provides a method for detecting suspicious groups in collaborative stock transactions based on a bipartite graph. According to the method, a set of suspicious accounts and a set of transaction events are collected before the following steps are executed.

In step S101), it is determined whether an update occurs in the set of suspicious accounts.

When original inputs are accepted to perform step S101) for the first time, the original inputs are accepted as the set of suspicious accounts ACC and the set of transaction events STK, and at least one of the original inputs has a valid value. In response to that step S101) is entered for the first time based on the original inputs and the set of suspicious accounts in the original outputs has a valid value, or in response to that step S101) is entered in a loop based on an algorithm and the set of suspicious accounts is updated relative to a previous entrance to step S101), the method proceeds to step S102); otherwise, the method proceeds to step S106).

An initial value of the set of suspicious accounts ACC in step S101) is a set of stock accounts that are confirmed to have abnormal transactions based on prior information or that are subjectively suspected of abnormal transactions. An arbitrary element in the set of suspicious accounts ACC in step S101), i.e., a suspicious account, is a personal stock account opened individually or an institutional stock account that was registered with a brokerage firm or other legal securities institutions and has been closed or is still in use.

An initial value of the set of transaction events STK in step S101) is a set of transaction events that are confirmed to have abnormal transactions based on prior information or that are subjectively suspected of abnormal transactions. An arbitrary element in the set of transaction events STK in step S101), that is, a transaction event, is a triplet including a traded stock stk, beginning time t_{b}, and end time tₑ. An abnormal transaction of the stock stk occurs between the beginning time t_{b} and the end time tₑ. The beginning time t_{b} is earlier than the end time tₑ. For the same transaction event, an interval between the beginning time t_{b} and the end time tₑ is not greater than a positive threshold tap. An arbitrary transaction event is denoted by (stk, t_{b}, tₑ)|t_{b}<tₑ, tₑ−t_{b}<t_{gap}, t_{gap}>0. In an actual division of transaction events, a time span t_{gap} of each transaction event and a beginning time to of detecting the suspicious groups in the collaborative stock transactions may be preset based on experience, so that for each stock stk, transaction events involving the stock are restricted to a set {(stk, t₀, t₀+t_{gap}),(stk,t₀+t_{gap}, t₀+2*t_{gap}), . . . , (stk,t₀+(k−1)*t_{gap},k*t_{gap}), (stk,t₀+k*t_{gap}, t_{now})|t_{now}<t₀+(k+1)*t_{gap}}, where t_{now} represents an end time of detecting the suspicious groups in the collaborative stock transactions.

In step S102), a transaction event is searched for.

A stock transaction defined in the present disclosure refers to an act of entrusting or revoking a dealing of one or more stocks in the secondary market by an independent personal stock account or an institutional stock account, regardless of whether the dealing of the one or more stocks is totally completed, partially completed, or totally uncompleted.

The historical stock transaction data defined in the present disclosure refers to all the stock transaction records of stock accounts within a time period specified in advance (if not specified in advance, the time period refers to a time period stared from when an account was opened) provided by regulatory and law enforcement agencies such as Securities Regulatory Commission, asset management agencies such as securities traders, and other data sources that may provide continuous and complete stock transaction information such as dealing and entrustments of some or all stock accounts.

In step S102), searching for the transaction event refers to retrieving the historical stock transaction data of all suspicious accounts in the set of suspicious accounts ACC. Among all the preset transaction events according to the description of step S101), each transaction event involved in the historical stock transaction data of all suspicious accounts in the set of suspicious accounts ACC is found out, and added to a set of candidate transaction events.

In step S103), a transaction event participation threshold is calculated.

The transaction event participation threshold THR_{STK} determines a minimum participation degree required for determining a candidate transaction event as a transaction event. The transaction event participation threshold may be determined based on a size of the set of transaction events, a size of the set of candidate transaction events, or iteration history, and may not be strictly increased as the iterative loop progresses. In an actual calculation of the transaction event participation threshold, the specific implementation of the calculation may be: determining that an n^{th} loop includes all operations included from a (2n−1)^{th} execution of step S101) to a 2n^{th} execution of step S105). A value of the transaction event participation threshold is determined as the natural logarithm of a number of loops, and calculated through the following formula:

THR_{STK}(n)=ln(n).

The calculation method of the transaction event participation threshold described in the present disclosure is merely illustrative, and those skilled in the art may adopt other calculation methods in accordance with practical requirements.

In step S104), the set of transaction events is updated.

A participation degree P_{STK} of each candidate transaction event in the set of candidate transaction events is calculated. Each candidate transaction event having a participation degree higher than the transaction event participation threshold THR_{STK} is selected and added to the set of transaction events STK. After the addition, the set of candidate transaction events is cleared.

The participation degree P_{STK} of each candidate transaction event describes a degree to which each candidate transaction event is principally participated by suspicious accounts. The calculation method of the participation degree P_{STK} of each candidate transaction event should match the transaction event participation threshold. During an actual update of the set of transaction events, if the transaction event participation threshold is calculated based on the specific implementation in step S103), the participation degree of each candidate transaction event may be calculated in the following calculation method. The participation degree of each candidate transaction event is determined as a number N_{ACC} of suspicious accounts that principally participate in the candidate transaction event in the set of suspicious accounts, that is, P_{STK}=N_{ACC}.

In step S105), it is determined whether the set of suspicious accounts and the set of transaction events have converged.

It is determined whether elements included in the set of suspicious accounts ACC and the set of transaction events STK are the same before and after a latest update. In response to that the elements included in the set of suspicious accounts and the set of transaction events are not the same, it is determined that the set of suspicious accounts and the set of transaction events have not converged, and then the method proceeds to step S101) to continue an iterative update of transaction events and suspicious accounts based on the bipartite graph. In response to that the elements included in the set of suspicious accounts and the set of transaction events are the same, it is determined that the set of suspicious accounts and the set of transaction events have converged, and then the method proceeds to step S109) for subsequent analysis and processing.

In step S106), a suspicious account is searched for.

For each transaction event (stk, t_{b}, tₑ) in the set of transaction events STK, historical stock transaction data generated in each transaction event is retrieved. That is, each stock account that has participated in at least one arbitrary transaction event in the set of transaction events are selected based on the historical transaction data of the stock stk in a period of time from the beginning time t_{b} to the end time tₑ, and each stock account selected is added to a set of candidate suspicious accounts.

In step S107), a suspicious account participation threshold is calculated.

The suspicious account participation threshold THR_{ACC} is used to determine a minimum participation degree required for determining a candidate stock account as a suspicious account. The suspicious account participation threshold may be calculated based on a size of the set of suspicious accounts, a size of the set of candidate suspicious accounts, or iteration history, and may not be strictly increased as the iterative loop progresses. In an actual calculation of the suspicious account participation threshold, the specific implementation of the calculation may lie in determining that an n^{th} loop includes all operations from a (2n−1)^{th} execution of step S101) to a 2n^{th} execution of step S105). A value of the suspicious account participation threshold is determined as the natural logarithm of a number of loops, and calculated through the following formula:

THR_{ACC}(n)=ln(n).

The calculation method of the suspicious account participation threshold described in the present disclosure is merely illustrative, and those skilled in the art may adopt other calculation methods in accordance with practical requirements.

In step S108), the set of suspicious accounts is updated.

A participation degree P_{ACC} of each candidate stock account in the set of candidate suspicious accounts is calculated. Each stock account having a participation degree higher than the suspicious account participation threshold THR_{ACC} is selected and added to the set of suspicious accounts ACC. After the addition, the set of candidate suspicious accounts is cleared.

The participation degree P_{ACC} of each stock account describes a degree to which each candidate stock account principally participates in transaction events. The calculation method the participation degree of each stock account should match the suspicious account participation threshold. During an actual update of the set of suspicious accounts, if the suspicious account participation threshold is calculated based on the specific implementation in step S107), the participation degree of each stock account may be calculated in the following calculation method. The participation degree of each stock account is determined as a number N_{STX} of transaction events in the set of transaction events principally participated by each stock account, that is, P_{ACC}=N_{STK}.

In step S109), a collaborative transaction graph among accounts is constructed.

For the set of suspicious accounts ACC and the set of transaction events STK, a collaboration degree SIM of stock transactions between any two suspicious accounts is calculated based on participation situations of the any two suspicious accounts in a transaction event. The collaborative transaction graph G_{SIM} among accounts describing collaboration situations of all suspicious accounts on all transaction events is constructed by taking each suspicious account as a node, taking a collaborative stock transaction between the any two suspicious accounts as an edge, and determining a collaboration degree of the any two suspicious accounts as a weight of the edge.

A collaboration degree SIM_{xy} of transactions between one stock account accₓ and another stock account acc_{y} in the set of suspicious accounts is a directed collaboration degree or an undirected collaboration degree, that is, a scalar collaboration degree that reflects an overall collaboration situation of the two suspicious accounts on respective events in the set of transaction events or a vectorial collaboration degree that independently reflects a collaboration situation of the two accounts on an event (stk, t_{b}, tₑ) in the set of transaction events STK in each dimension. In an actual calculation of the collaboration degree, it is proposed to adopt a default calculation method of the collaboration degree, which may be implemented as follows. Stock accounts accₓ and acc_{y} are set to principally participate in nₓ transaction events and n_{y} transaction events, respectively, and set to principally participate in n_{x&y} transaction events together, then the collaboration degree of the stock accounts accₓ and acc_{y} is an arithmetic mean of a ratio of the n_{y} transaction events that the stock accounts accₓ and acc_{y} principally participate in together to the nₓ transaction events that the stock account accₓ principally participates in and a ratio of the n_{y} transaction events that the stock accounts accₓ and acc_{y} principally participate in together to the n_{y} transaction events that the stock account acc_{y} principally participates in. The calculation equation of the collaboration degree is denoted by:

$${SIM}_{x y} = ( \frac{{n}_{x \& y}}{{n}_{x}} + \frac{{n}_{x \& y}}{{n}_{y}} ) / 2.$$

In step S110), a group division is performed based on the collaborative transaction graph among accounts.

Community division of suspicious accounts may be performed based on an overlapping community discovery or a non-overlapping community discovery adapted to the collaborative transaction graph G_{SIM}. With weight characteristics of collaboration degrees SIM of transactions among different accounts being reflected, account communities each having the close internal collaboration may be divided based on the collaboration degrees of transactions.

In a case where the default calculation method of the collaboration degree is adopted, for the collaborative transaction graph G_{SIM} generated based on the set of suspicious accounts and the set of transaction events, it is proposed to adopt a DBSCAN algorithm to divide the collaborative transaction graph G_{SIM} into subgraphs (G_{SIM,1}), (G_{SIM,2}), (G_{SIM,3}) . . . and scatter points. Each subgraph is set to represent an account community. Stock accounts corresponding to all nodes included in a subgraph form a suspicious group in collaborative stock transactions of an account community corresponding to the subgraph, and transaction events corresponding to all edges included in the subgraph form a group of transaction events in the account community.

The suspicious group in the collaborative stock transactions described in the present disclosure refers to a set of stock accounts that synchronously participate in all transaction events in a corresponding group of transaction events and that further potentially affect a stock price trend of a related stock.

Multiple account communities each having the close internal collaboration are determined as suspicious groups in the collaborative stock transactions. Transaction events manipulated or participated by the suspicious groups are determined as a group of transaction events. The suspicious groups in the collaborative stock transactions and the group of transaction events manipulated or participated by the suspicious groups are outputted, and detection is terminated.

The close internal collaboration means that a ratio of a number of edges E of any two accounts having a collaboration degree SIM not smaller than a threshold SIM₀ in an account community to a number of theoretically fully connected edges E_{c} of the any two accounts is not smaller than a threshold Pᵢₙₜ, that is,

$$\frac{E}{{E}_{c}} \geq {P}_{i n t} ,$$

where SIM₀>0, 0<Pᵢₙₜ<1. Both SIM₀ and Pᵢₙₜ are empirical parameters, which may be determined based on the actually adopted calculation method of the collaboration degree, data analyses of the stock market, and business experience. When the default calculation method of the collaboration degree is adopted, a recommended value for SIM₀ is 0.3, and a recommended value for Pᵢₙₜ is 0.3.

The transaction event participation threshold THR_{STK} in step S103) and the suspicious account participation threshold THR_{ACC} in step S107) should be determined using the same or similar calculation method, so as to ensure symmetry and consistency of iterative updates of the transaction events and the suspicious accounts based on the bipartite graph.

Expressions “principally participated by/principally participates in” defined in step S104) and step S108) refer to a transaction behavior of investing most of the money in an account to a certain stock within a certain period of time, or a transaction behavior that although most of the money in the account is not invested to the stock, a transaction volume or transaction value of the account has obviously affected the normal transaction of the stock. In reality, “principally participated by/principally participates in” may be defined as follows: a sum SUM_{AMT}_{_{acc}} (a sum of a total purchase amount and a total sale amount) of transaction amounts of any suspicious account acc in any transaction event (stk, t_{b}, tₑ) is greater than an amount threshold THR_{AMT}, or the sum SUM_{AMT}_{_{acc}} of transaction amounts is greater than a certain percentage RAT_{AMT} of an average daily transaction amount AVG_{AMT}_{ₛₜₖ} of a stock stk within a period of the transaction event, that is, from the beginning time t_{b} to the end time tₑ. That is to say, when SUM_{AMT}_{_{acc}}>THR_{AMT} or SUM_{AMT}_{_{acc}}>AVG_{AMT}_{ₛₜₖ} RAT_{AMT}, it is determined that the suspicious account acc principally participates in the transaction event (stk,t_{b}, tₑ), where THR_{AMT}>0, and RAT_{AMT}>0. Both THR_{AMT} and RAT_{AMT} are empirical parameters, which may be determined based on data analyses of the stock market and business experience. It is recommended to set a value of THR_{AMT} as 1,000,000 RMB, and RAT_{AMT} as 0.001.

There are two types of illegal stock operations.

The first type is defined as individual behaviors. This type of behaviors shows strong personal will and is irregular. However, with the help of technical means, various rules may be set to perform effective detections on this type of behavior.

The second type is defined as collaborated violations against supervision rules, which is intended to prevent each account from presenting obvious maliciousness through collaboration of multiple accounts. However, the related art cannot mine or discover the collaboration among different accounts from a massive amount of data, and thus cannot achieve effective detections.

With respect to the second type of problem, the historical stock transaction data of the suspicious accounts are retrieved to construct the transaction event based on the historical stock transaction data so as to update the set of transaction events. The stock account participating in the transaction event is located, and the suspicious account involved in the transaction events is filtered out to update the set of suspicious accounts. The iterative loop is performed on the above process in a certain order until the set of transaction events and the set of suspicious events have converged. The collaborative transaction graph among accounts is constructed by determining each suspicious account as the node and the collaboration situation among the any two accounts on the transaction events as the edge. The community discovery is performed on the collaborative transaction graph among accounts to detect account communities. And then, the suspicious groups in the collaborative stock transactions and corresponding transaction events are obtained. Consequently, collaboration among different accounts may be discovered and determined.

It may be understood from common technical knowledge that the present disclosure may be implemented by other embodiments that do not depart from the spirit or essential features of the present disclosure. Therefore, the above embodiments are merely illustrative in all aspects, rather than the only embodiments for the present disclosure. All changes made within the scope of the present disclosure or within a scope equivalent to the present disclosure should be included in the present disclosure.

What is claimed is:

1. A method for detecting suspicious groups in collaborative stock transactions based on a bipartite graph, comprising collecting a set of suspicious accounts and a set of transaction events, the method further comprising:
step S101) of determining whether an update occurs in the set of suspicious accounts: in response to that the update occurs, proceeding to step S102); otherwise, proceeding to step S106);
step S102) of searching for a transaction event: retrieving historical stock transaction data of each suspicious account in the set of suspicious accounts to construct a transaction event, and adding the constructed transaction event to a set of candidate transaction events;
step S103) of calculating a transaction event participation threshold: calculating the transaction event participation threshold based on a size of the set of transaction events, a size of the set of candidate transaction events, or iteration history;
step S104) of updating the set of transaction events: calculating a participation degree of each candidate transaction event in the set of candidate transaction events, selecting a candidate transaction event having a participation degree higher than the transaction event participation threshold, and adding the candidate transaction event having the participation degree higher than the transaction event participation threshold to the set of transaction events; and after the addition, clearing the set of candidate transaction events;
step S105) of determining whether the set of suspicious accounts and the set of transaction events have converged: determining whether elements comprised in the set of suspicious accounts and the set of transaction events are the same before and after a latest update; in response to that the elements comprised in the set of suspicious accounts and the set of transaction events are not the same, determining that the set of suspicious accounts and the set of transaction events have not converged, and proceeding to step S101); and in response to that the elements comprised in the set of suspicious accounts and the set of transaction events are the same, determining that the set of suspicious accounts and the set of transaction events have converged, and proceeding to step S109);
step S106) of searching for a suspicious account: retrieving historical stock transaction data generated in each transaction event in the set of transaction events to select a stock account that has participated in at least one arbitrary transaction event in the set of transaction events, and adding the stock account selected to a set of candidate suspicious accounts;
step S107) of calculating a suspicious account participation threshold: calculating the suspicious account participation threshold based on a size of the set of suspicious accounts, a size of the set of candidate suspicious accounts, or iteration history;
step S108) of updating the set of suspicious accounts: calculating a participation degree of each stock account in the set of candidate suspicious accounts, selecting a stock account having a participation degree higher than the suspicious account participation threshold as a suspicious account, and adding the suspicious account selected to the set of suspicious accounts; and after the addition, clearing the set of candidate suspicious accounts;
step S109) of constructing a collaborative transaction graph among accounts: constructing the collaborative transaction graph among accounts describing collaboration situations of all suspicious accounts on all transaction events; and
step S110) of performing a group division based on the collaborative transaction graph among accounts: dividing the collaborative transaction graph among accounts into a plurality of account communities each having close internal collaboration based on a collaboration degree, determining the plurality of account communities each having the close internal collaboration as the suspicious groups in the collaborative stock transactions, and determining transaction events manipulated or participated by the suspicious groups as a group of transaction events; and outputting the suspicious groups in the collaborative stock transactions and the group of transaction events manipulated or participated by the suspicious groups, and terminating the detecting.

2. The method according to claim 1, wherein in response to performing step S101) for the first time, original inputs are accepted as the set of suspicious accounts and the set of transaction events, and at least one of the original inputs has a valid value; in response to that step S101) is entered for the first time based on the original inputs and the set of suspicious accounts in the original outputs has a valid value, or in response to that step S101) is entered in a loop based on an algorithm and the set of suspicious accounts is updated relative to a previous entrance to step S101), the method proceeds to step S102); otherwise, the method proceeds to step S106).

3. The method according to claim 1, wherein an initial value of the set of transaction events in step S101) is a set of transaction events that are confirmed to have abnormal transactions based on prior information or that are subjectively suspected of abnormal transactions, an arbitrary element in the set of transaction events in step S101) that is a transaction event is a triplet comprising a traded stock stk, beginning time t_{b}, and end time tₑ, and an abnormal transaction of the stock stk occurs between the beginning time t_{b} and the end time tₑ, the beginning time t_{b} being earlier than the end time tₑ, and for the same transaction event, an interval between the beginning time t_{b} and the end time tₑ being not greater than a positive threshold tap; and an arbitrary transaction event is denoted by (stk, t_{b}, tₑ)|t_{b}<tₑ, tₑ−t_{b}<t_{gap}, t_{gap}>0.

4. The method according to claim 1, wherein the stock transaction in step S102) and step S106) refers to an act of entrusting or revoking a stock transaction entrustment performed by a stock account, regardless of whether the stock transaction is closed or not.

5. The method according to claim 1, wherein the transaction event participation threshold THR_{STK} in step S103) determines a minimum participation degree required for determining a candidate transaction event as a transaction event, and the suspicious account participation threshold THR_{ACC} in step S107) determines a minimum participation degree required for determining a candidate stock account as a suspicious account, the transaction event participation threshold and the suspicious account participation threshold being determined through the same or similar calculation method, and being not strictly increased as an iterative loop progresses.

6. The method according to claim 1, wherein the participation degree P_{STK} of each candidate transaction event in step S104) describes a degree to which each candidate transaction event is principally participated by suspicious accounts, and the participation degree P_{ACC} of each stock account in step S108) describes a degree to which each candidate stock account principally participates in transaction events, the participation degree P_{STK} and the participation degree P_{ACC} being determined through the same or similar calculation method, and matching respective participation thresholds.

7. The method according to claim 1, wherein step S109) comprises: for the set of suspicious accounts and the set of transaction events, calculating a collaboration degree SIM of stock transactions between any two suspicious accounts based on participation situations of the any two suspicious accounts in a transaction event, constructing the collaborative transaction graph G_{SIM} among accounts describing collaboration situations of all suspicious accounts on all transaction events by taking each suspicious account as a node, taking a collaborative stock transaction between the any two suspicious accounts as an edge, and determining a collaboration degree of the any two suspicious accounts as a weight of the edge.

8. The method according to claim 7, wherein a collaboration degree SIM_{xy} of transactions between one stock account accₓ and another stock account acc_{y} in the set of suspicious accounts is a directed collaboration degree or an undirected collaboration degree, that is, a scalar collaboration degree that reflects an overall collaboration situation of the two accounts on respective events in the set of transaction events or a vectorial collaboration degree that independently reflects a collaboration situation of the two accounts on an event (stk, t_{b}, tₑ) in the set of transaction events in each dimension.

9. The method according to claim 1, wherein the close internal collaboration in step S110) means that a ratio of a number of edges E of any two accounts having a collaboration degree SIM not smaller than a threshold SIM₀ in an account community to a number of theoretically fully connected edges E_{c} of the any two accounts is greater than or equal to a threshold Pᵢₙₜ, that is,
$$\frac{E}{{E}_{c}} \geq {P}_{i n t} ,$$
where 0<Pᵢₙₜ<1.

10. The method according to claim 1, wherein each of the plurality of suspicious groups in the collaborative stock transactions in step S110 is a set of stock accounts that synchronously participate in all transaction events in a corresponding group of transaction events and that further potentially affect a stock price trend of a related stock, and the suspicious groups in the collaborative stock transactions and a corresponding group of transaction events are final outputs of the method for detecting the suspicious groups in the collaborative stock transactions.
